(19) United States
(12) Patent Application Publication
(10) Pub. No.: US 2008/0120375 A1
(43) Pub. Date: May 22, 2008

(54) ACTIVITY PARTNER MATCHING SYSTEM AND METHOD

(76) Inventor: Benjamin Levy, San Francisco, CA (US)

Correspondence Address: AXIOS LAW GROUP. PLLC, 1525 FOURTH AVENUE, SUITE 800, SEATTLE, WA, 98101, US

(21) Appl. No.: 11/940,238

(22) Filed: Nov. 14, 2007

Related U.S. Application Data
(60) Provisional application No. 60/866,189, filed on Nov. 16, 2006.

(51) Int. Cl. G06F 15/16

(52) U.S. Cl. 709/204

(57) ABSTRACT

Systems and methods are provided herein that provide for computer implemented matching of activity partners.

### RELATED REFERENCES

This application claims priority to U.S. Provisional Application 60/866,189 filed Nov. 16, 2006. The foregoing application is hereby incorporated by reference in its entirety as if fully set forth herein.

### FIELD

This invention relates generally to introducing people, and more specifically, to systems and methods for matching activity partners.

### BACKGROUND

People have been gathering to participate in activities ever since the beginning of man. For example, regarding sports, ancient Chinese artifacts suggest that sporting events occurred as early as 4000 BC, which further suggests that less formal sporting activities likely occurred even earlier. Additionally, monuments to Egyptian Pharaohs indicate that sports such as swimming and fishing were well established in those times. Today, sports and other activities are an integral aspect of the lives of almost every person, and for many, on a daily basis. Accordingly, ways of facilitating activities and sports have become important in modern times.

Simply put, people are busy, and it has become increasingly difficult for people to schedule time for activities and moreover to find people to participate in activities with. Currently, there are tools such as websites that allow users to search for people near them who have a similar desire to participate in certain activities. Typically, these websites allow users to input their zip code and search for people within a certain radius of their area code. Additionally, users can filter their searches by variables such as gender, types of activity, and skill level in the types of activity. While these websites potentially provide a way for users to connect and participate in activities together, they do not efficiently allow activity partners to connect.

First, many websites simply comprise a plurality of profiles which were created by users, where users define sports or other activities that they are interested in and possibly skill level in these sports or activities. Unfortunately, although it may seem like there are a great number of users on these websites because of the large plurality of profiles, the reality is that the great majority of these profiles do not represent active users. Typically, most users of these websites create a profile and do not actually participate in activities with others, become dissatisfied with the service, or simply forget about their profile. These profiles remain searchable by users who are actually interested in participating in activities, which makes searching for activity partners inefficient and many times unsuccessful.

Next, many matching websites simply comprise profiles which express users interest in participating in various activities, their location, and possibly their skill level in these activities. Unfortunately, many of these websites do not allow users to define when they desire to participate in specific activities, and those that do simply allow users to express when they are generally available to participate in activities such as specific times of the week. These methods are also undesirable because few people are actually available to participate in activities on a recurring basis, which makes matching with other people inefficient. A user may have personal or professional obligations that get in the way, or a user may have already booked an activity with another activity partner.

### BRIEF DESCRIPTION OF THE DRAWINGS

The present invention will be described by way of exemplary embodiments but not limitations, illustrated in the accompanying drawings in which like references denote similar elements, and in which:

FIG. 1 is a pictorial diagram of an activity partner matching system of interconnected devices, in accordance with various embodiments.

FIG. 2 is a block diagram of a device that provides an exemplary operating environment for various embodiments.

FIG. 3 is a screen shot of a module of a profile component, in accordance with an embodiment.

FIG. 4 is a screen shot of another module of a profile component, in accordance with an embodiment.

FIG. 5 is a screen shot of a still further module of a profile component, in accordance with an embodiment.

FIG. 6 is a screen shot of a module of a searching component, in accordance with an embodiment.

FIG. 7 is a screen shot of a time and date matrix of a searching component, in accordance with an embodiment.

FIG. 8 is a screen shot of a still further module of a searching component, in accordance with an embodiment.

FIG. 9 is a screen shot on an even further module of a searching component, in accordance with an embodiment.

FIG. 10 is a screen shot of a module of a scheduling component, in accordance with an embodiment.

FIG. 11 is a screen shot of another module of a scheduling component, in accordance with an embodiment.

FIG. 12 is a screen shot of a still further module of a scheduling component, in accordance with an embodiment.

FIG. 13 is a diagram illustrating the actions taken by a first and second user device, and a matching server in accordance with various embodiments.

FIG. 14 is a flow diagram illustrating a user profile routine in accordance with various embodiments.

FIG. 15 is a flow diagram illustrating a user posting routine in accordance with various embodiments.

FIG. 16 is a diagram illustrating the actions taken by a first and second user device in accordance with various embodiments.

FIG. 17 is a flow diagram illustrating an activity partner matching routine in accordance with various embodiments.

### DESCRIPTION

Illustrative embodiments presented herein include, but are not limited to, systems and methods for matching activity partners.

Various aspects of the illustrative embodiments will be described using terms commonly employed by those skilled in the art to convey the substance of their work to others skilled in the art. However, it will be apparent to those skilled in the art that the embodiments described herein may be practiced with only some of the described aspects. For purposes of explanation, specific numbers, materials and configurations are set forth in order to provide a thorough understanding of the illustrative embodiments. However, it will be apparent to one skilled in the art that the embodiments described herein may be practiced without the specific details. In other instances, well-known features are omitted or simplified in order not to obscure the illustrative embodiments.

Further, various operations and/or communications will be described as multiple discrete operations and/or communications, in turn, in a manner that is most helpful in understanding the embodiments described herein; however, the order of description should not be construed as to imply that these operations and/or communications are necessarily order dependent. In particular, these operations and/or communications need not be performed in the order of presentation.

The phrase “in one embodiment” is used repeatedly. The phrase generally does not refer to the same embodiment; however, it may. The terms “comprising,” “having” and “including” are synonymous, unless the context dictates otherwise.

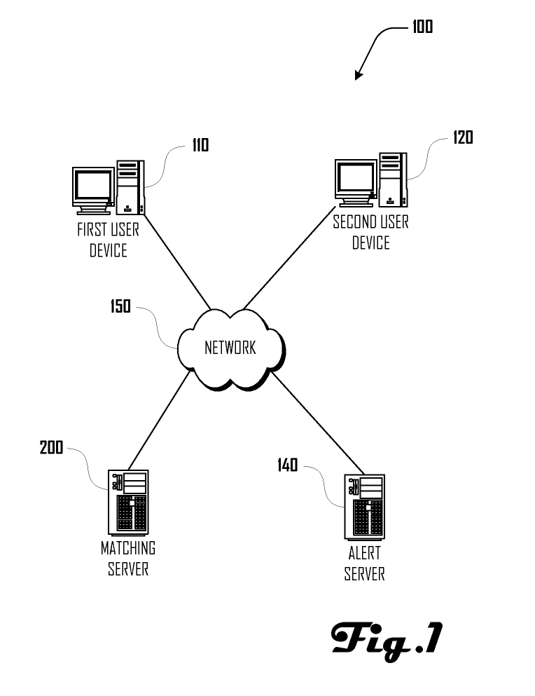

FIG. 1 is a block diagram of an activity partner matching system 100 in accordance with one exemplary embodiment, which comprises a first user device 110, a second user device 120, a matching server 200, and an alert server 140, which are each operationally connected via a network 150. A first user is associated with the first user device 110 and a second user is associated with the second user device 120. The matching server 200 can comprise a plurality of components, including a scheduling component, a profile component, a communication component, a posting component, a search component, a database, and the like. The matching server 200 is configurable to allow the first and second user device 110, 120 to create and store a profile, which can include one or more activity that the first or second user desires to participate in, skill level in a given activity, and one or more specific date, time or time frame, place that they would like to participate in one or more activity, and the like. The matching server 200 is further configurable to allow the first user device 110 to search for specific, general or ranges of dates and times that the second user is available to participate in a given activity and to further limit the search to one or more location or the skill level of the second user in a given activity. The matching server 200 is also configurable to allow the second user device 120 to perform the same functions in relation to the first user device 110.

The matching server 200 is further configurable to allow the first user device 110 to book an activity with the second user device 120 and to allow the second user device 120 to book an activity with the first user device 110. Additionally, the alert server 140 is configurable to send an alert to the second user device 120. For example, if the first user device 110 cancels an activity booked with the second user device 120, the matching server 200 can communicate with the alert server 140 to send an alert to the second user device 120 that the first user device 110 has cancelled the booked activity. In another example, the second user 120 can configure the matching server 200 to communicate with the alert server 140 to send the second user device 120 an alert to remind the second user of a booked activity that the second user device 120 has booked with the first user device 110, and the alert can be sent at a designated time or time interval before the booked activity.

In one embodiment, the alert server 140 can send or communicate any type of alert to the second user, including, but not limited to a text message, multimedia text message, e-mail, voicemail, fax, letter, or the like. In a further embodiment, the alert server 140 can be absent or can be a part of the matching server 200. In another embodiment, the alert server 140 can be in direct communication with the first user device 110 or send an alert to the first user device 110, or another device associated with the first user such as a cellular telephone, personal data assistant, laptop computer, global positioning system device, or the like. In a still further embodiment, there can be a plurality of users who can be in communication with the matching server 200, who can each create a profile, search for activity postings posted by other users, book activities with another user, send alerts to another user, communicate with another user, send an alert to themself, configure the matching server 200, or the like. In a still further embodiment the first and second user can be one or both of a requesting activity partner or a posting activity partner.

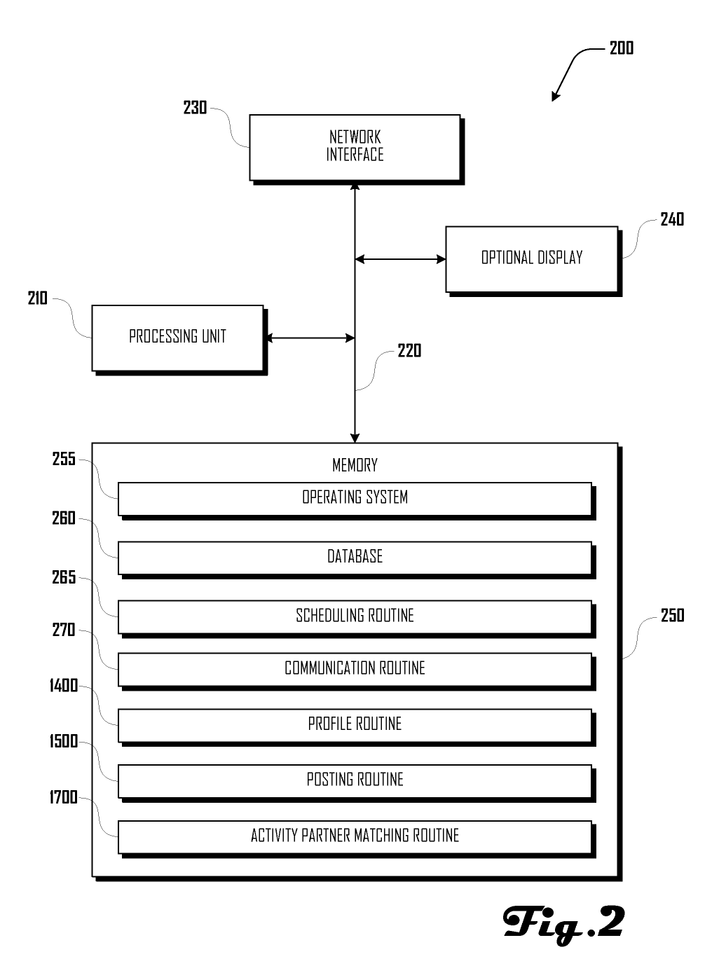

FIG. 2 illustrates several components of an exemplary matching server 200 for an embodiment. For example, the matching server 200 can be embodied in the operating environment depicted in FIG. 2. Those of ordinary skill in the art and others will appreciate that the matching server 200 may include many more components than those shown in FIG. 2. However, it is not necessary that all of these generally conventional components be shown in order to disclose an enabling embodiment for practicing the embodiments described herein. As shown in FIG. 2, the matching server 200 includes a network interface 230 for connecting to remote devices (not shown). The network interface 230 may be a network interface designed to support a local area network (“LAN”), wireless local area network (“WLAN”), personal area network (“PAN”), telephone network, powerline connection, serial bus, universal serial bus (“USB”) wireless connection, or the like. The network interface 230 includes the necessary circuitry, driver and/or transceiver for such a connection and is constructed for use with the appropriate protocols for such a connection.

The matching server 200 also includes a processing unit 210, an optional display 240 and a memory 250, all interconnected along with the network interface 230 via a bus 220. Those of ordinary skill in the art and others will appreciate that the display 240 may not be necessary in all forms of computing devices and, accordingly, is an optional component. The memory 250 generally comprises random access memory (“RAM”), a read only memory (“ROM”) and a permanent mass storage device, such as a disk drive, flash RAM, or the like. The memory 250 stores the program code necessary for a scheduling routine 265, a communication routine 270, a profile routine 1400, a posting routine 1500, and an activity partner matching routine 1700. Additionally, the memory 250 stores an operating system 255 and a database 260.

It will be appreciated that the software components may be loaded from a computer readable medium into memory 250 of the matching server 200 using a drive mechanism (not shown) or network associated with the computer readable medium, such as a floppy, tape, digital video disc (DVD)/CD-ROM drive, flash RAM, network interface 230 or the like.

The profile routine 1400 is configurable to facilitate one or more user to input, edit and change one or more piece of information about the one or more user, which is stored in the database 260. The one or more piece of information about the one or more user can include, but is not limited to, email address, password, first name, last name, middle name, user identification, age, age group, gender, country, zip code, industry that the one or more user works in, work position, primary language, secondary language, gym affiliation, one or more sport that the one or more user desires to participate in, one or more activity that the one or more user desires to participate in, skill level in one or more sport or activity, one or more location that the one or more user desires to participate in one or more activity, birth date, consent to one or more contract or agreement, contact preferences, a date and time or date and time period that the user desires to participate in one or more sport or activity, one or more recurring time of the week that the user desires to participate in one or more sport or activity, notes associated with one or more date and time, date and time period, or recurring time of the week that the user desires to participate in one or more activity, telephone number, fax number, IP address, Instant Messager® identification, Skype® number, information about one or more user of the matching server, credit card information, religion, and the like.

The activity partner matching routine 1700 is configurable to allow a user to search for one or more piece of information input, edited, or changed by one or more user, which is stored in the database 260. The activity partner matching routine 1700 is further configurable to allow a user to search for and display or present one or more user who desires to participate in a selected sport or activity or search for and display or present one or more posing made by a user who desires to participate in a selected sport or activity. Additionally, the activity partner matching routine 1700 is configurable to search for and present or display profiles of all users who are proximate to a selected location, or postings for activities that are proximate to a selected location. Furthermore, the activity partner matching routine 1700 is further configurable to allow a user to search for and display or present one or more posting of users who desire to participate in a selected sport or activity, within a given proximity to a given location, and to further filter the results by one or more parameter, which can be any class, group or type of information that can be stored in the database 260. The activity partner matching routine 1700 is further configurable to allow a user to view information about one or more user, or to view the profile of one or more user.

The scheduling routine 265 is configurable to allow a user to book, change, and cancel an activity meeting with another user, and the like. Additionally, the scheduling routine 265 is configurable to allow a user to post one or more date and time, date and time period, or recurring time or time period of the week that the user desires to participate in one or more activity. The scheduling routine 265 is in communication with the database 260, which stores the one or more posting of a date and time, date and time period, or recurring time or time period of the week that one or more user desires to participate in one or more activity, and the like. A user can view one or more date and time, date and time period, or recurring time or time period that the user has input as being available to participate in a given activity and designate the activity as being booked or open. In one embodiment, a posting marked as booked will not be searchable by other users.

The communication routine 270 allows one or more user to communicate with one or more other user. The communication routine 270 is configurable to facilitate communication between one or more user in any way that communication is achieved. For example, a first user can input a message that can be stored in the database 260 and which can subsequently be viewed by a second user. The second user can then input a reply message that can be stored in the database 260 and which can subsequently be viewed by the first user. Similarly, in one embodiment, the communication routine 270 can be configured to facilitate any type of communication such as a voice mail, instant messages, text message or email.

The database 260 stores one or more piece, packet, or group of information that is communicated to or from any of the scheduling routine, communication routine, profile routine, posting routine, or activity partner matching routine 265, 270, 1400, 1500, 1700 or any other routine, and the one or more piece, packet, or group of information stored in the database can be viewed, edited, changed, replaced, or deleted by any of the scheduling routine, communication routine, profile routine, posting routine, or activity partner matching routine 265, 270, 1400, 1500, 1700 or any other routine.

In the following figures, the scheduling routine, communication routine, profile routine, posting routine, or activity partner matching routine 265, 270, 1400, 1500, 1700 are depicted in one embodiment, namely embodied in a website. In this embodiment, the website can be hosted on a server and can be accessed and configured by one or more user over the internet, or one or more user can be in communication with the server hosting the website through the internet and by any device such as a computer, laptop computer, cellular telephone, personal data assistant, gaming system, or the like. In one embodiment, the scheduling routine, communication routine, profile routine, posting routine, or activity partner matching routine 265, 270, 1400, 1500, 1700 can be absent or can be embodied in another component or routine. Additionally, it will be clear to one reasonably skilled in the art that the depiction of the following embodiment can be substantially changed, modified, and arranged and nonetheless comport with the spirit of the embodiments described herein.

Although an exemplary matching server 200 has been described that generally conforms to conventional general-purpose computing device, those of ordinary skill in the art will appreciate that a matching server 200 may be any of a great number of devices capable of functioning as a device, server or operating environment that is within the spirit or scope of the embodiments described herein or can perform at least one function of the embodiments described herein.

In one exemplary embodiment, a first or second user device 110, 120 can configure or interact with the matching server 200 using a graphical user interface. An example of a graphical user interface is an interactive web page, e.g., in HTML (HyperText Markup Language), Flash, JavaScript, VBScript, JScript, ASP.NET, PHP (HTML Preprocessor) or XHTML (eXtensible HyperText Markup Language) form, or the like. Resultantly, since users are generally familiar with the user interfaces of web pages, including sophisticated web pages such as Flash-enabled web pages from Macromedia, Incorporated of San Francisco, Calif., consumption of peer to peer device services using a web page based graphical user interface on a peer to matching server 200 (e.g., displayed on the peer to peer display 240) may be made familiar and user friendly.

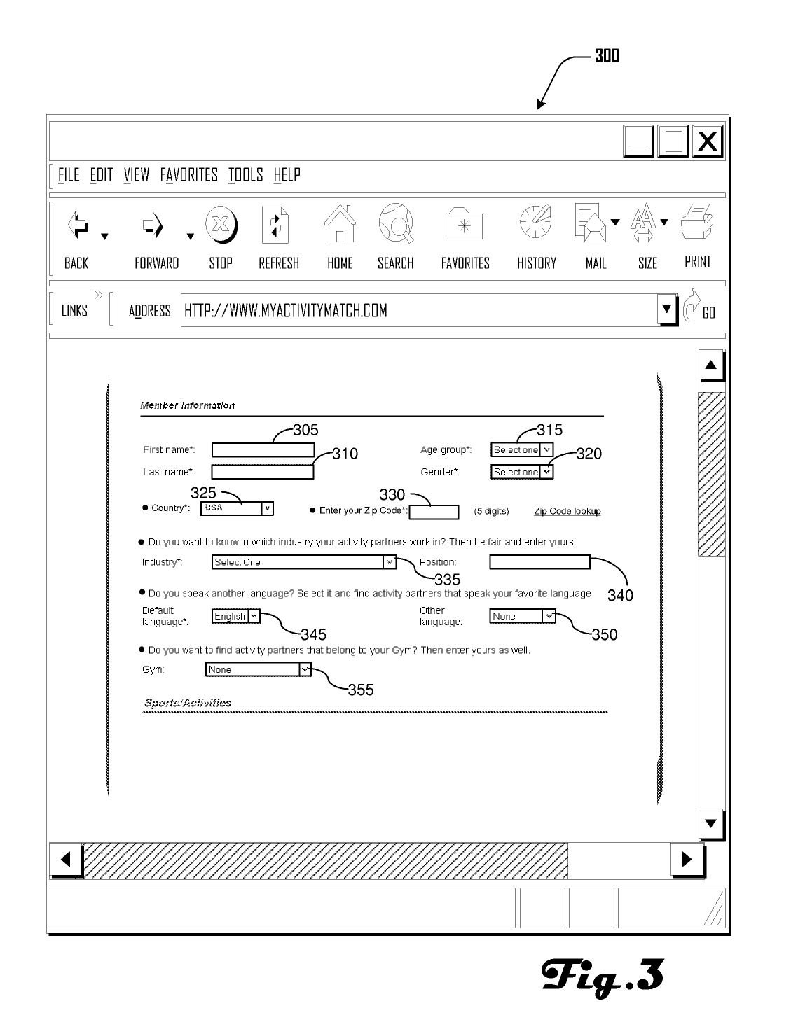

FIG. 3 is a screen shot of a module of a profile component 300, in accordance with one embodiment, which comprises a first name field 305, a last name field 310, an age group box 315, a gender box 320, a country box 325, a zip code box 330, an industry box 335, a position field 340, a default language box 345, an other language box 350, and a gym affiliation box 355. This module of the profile component 300 allows a new user to input and submit personal information. The first name field 305, and last name field 31 0 allow a user to input the user's first and last name respectively. The age group box 315 is a drop down box that allows a user to select the age range that the user belongs to. In another embodiment, the user can input a specific age or a birth date. The industry box 335 is a drop-down box that allows a user to select the industry in which the user works, and the position field 340 allows a user to input the user's position at the user's job, such as president, vice-president, partner, member or associate. Additionally, the default and other language box 340, 350 are configurable to allow a user to input a primary and secondary spoken language that the user speaks. Finally, the gym affiliation box 355 allows a user to select a gym that the user is affiliated with, which can include, but is not limited to gyms such as Bally's, 24 Hour Fitness, and Gold's Gym.

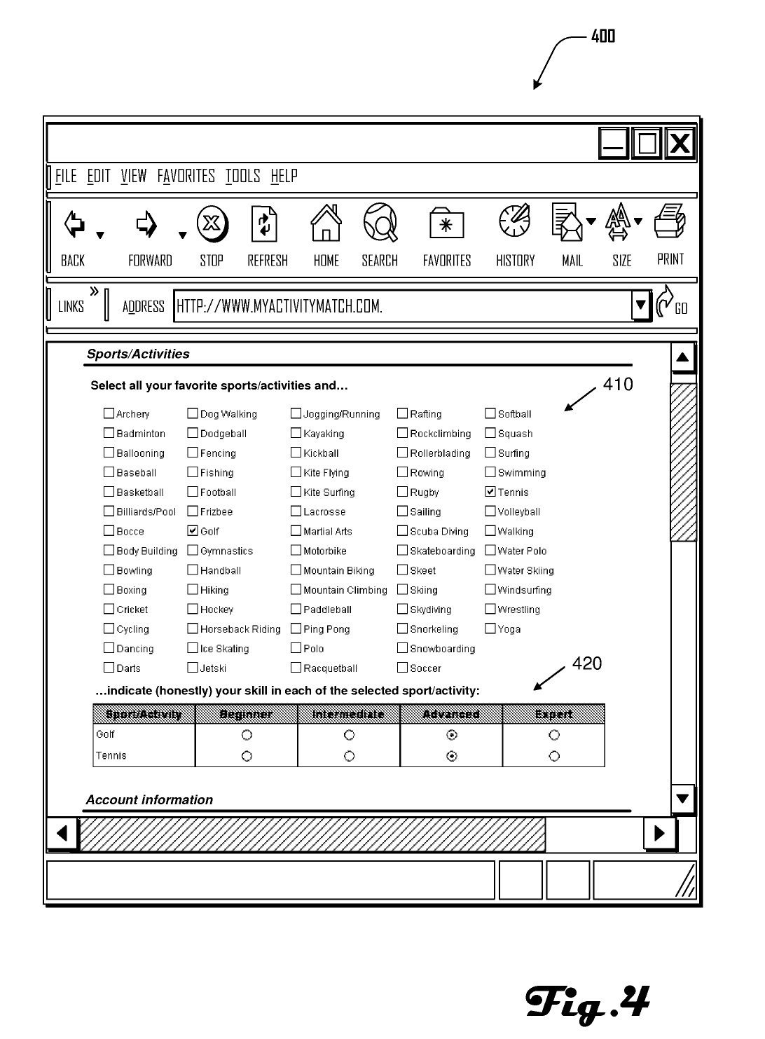

FIG. 4 is a screen shot of another module of a profile component 400, in accordance with one embodiment, which comprises a plurality of activity check-boxes 410 and a skill-level selection box 420. The plurality of activity check-boxes 410 allow a user to select sports or activities that a user desires to participate in, and the skill-level selection box 420 displays a row of radio buttons for each activity selected in the plurality of activity check-boxes 410, which allow a user select the user's skill level at each selected activity, including skill levels such as beginner, intermediate, advanced, and expert.

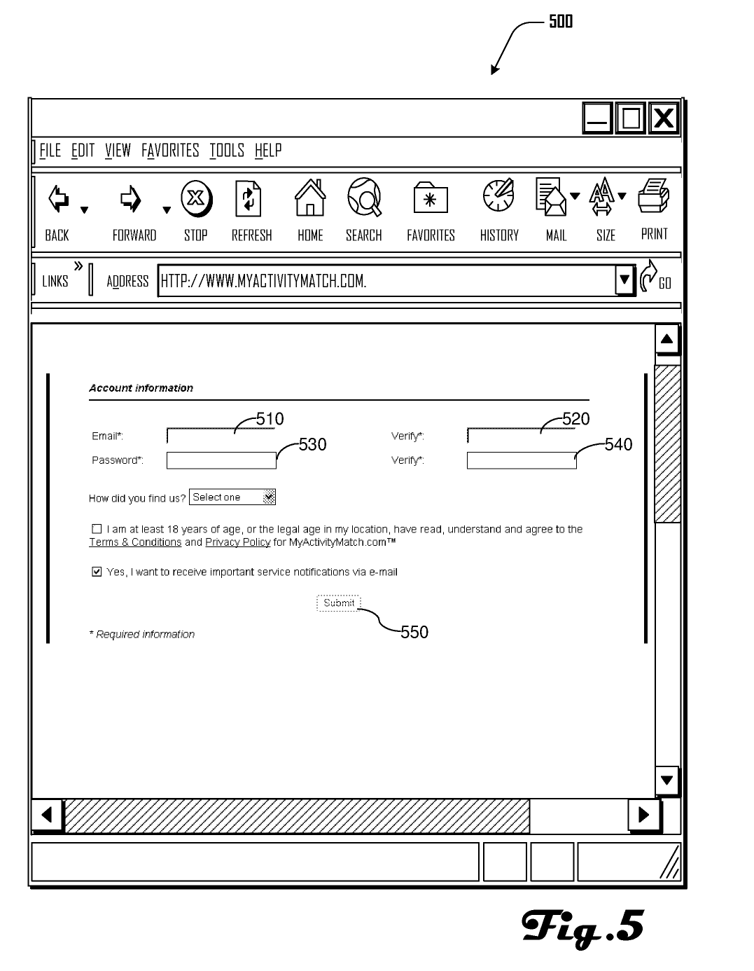

FIG. 5 is a screen shot of a still further module of a profile component 500, in accordance with one embodiment, which comprises an email field 510, and email verification field 520, a password field 530 a password verification field 540, and a submit button 550. The email and email verification field, 510, 520 allow a user to input and verify the user's email address. The password and password verification field, 530, 540 allow a user to input and verify the user's selected password. The submit button 550, allows a user to submit information input or selected in the aforementioned fields to a database. In one embodiment, the submit button 550 allows a user to submit the information input or selected in the modules of the profile component depicted in FIGS. 3-5. In a further embodiment, a user can edit, change or delete information submitted or selections made in the fields or boxes or buttons of FIGS. 3-5.

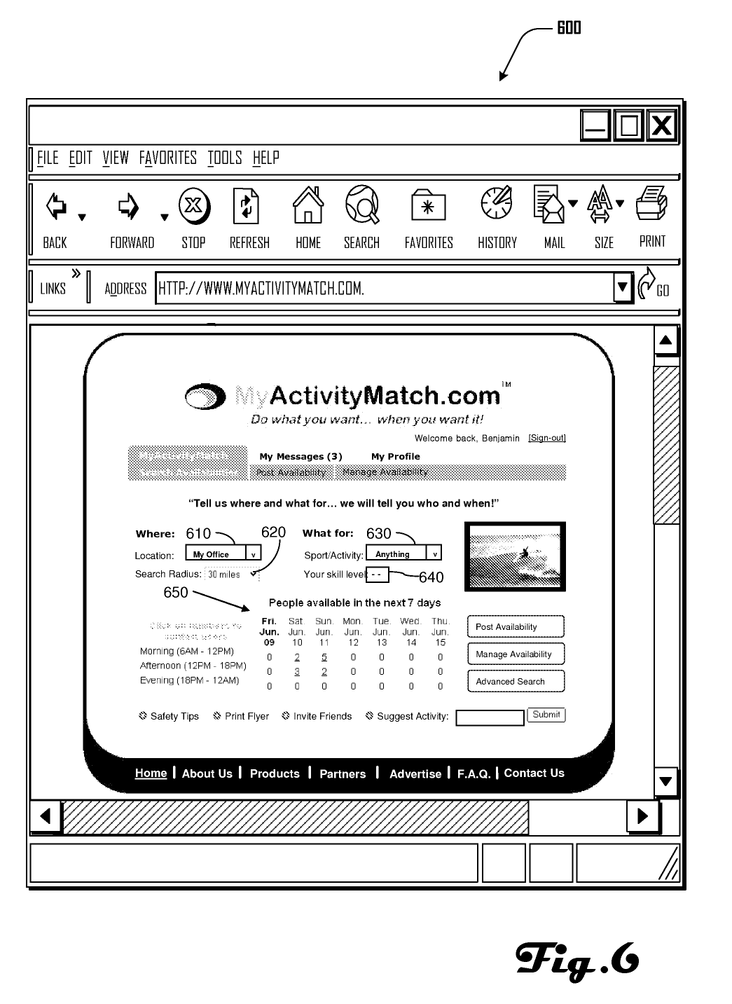

FIG. 6 is a screen shot of a module of a searching component 600, in accordance with one embodiment, which comprises a location box 610, a radius box 620, an activity box 630, a skill level box 640, and a time and date matrix 650. The module of the searching component 600 allows a user to search the data and information contained in a database for information, data, or postings that relate to a date and time, date and time period, or recurring time or time period that one or more other users desire to participate in one or more activity. The user can select a location that the user desires to participate in an activity by selecting a location in the location box 610, which in one embodiment can be associated with an area code. The user can further select a radius, skill level and activity to search for, or within, by selecting these variables in the radius box 620, the activity box 630, and skill level box 640. In one embodiment, a user can select any radius to search from a defined area code, including any integer such as 1, 2, 3, 4, 5, 10, 15, 20, 25, 30, 35, 40, 45, 50, 100, 150 and so forth. Additionally, a user can select one or more sport or activity to search for, which can be a set comprising any sport or activity, a selected group of sports or activities, or a single sport or activity. A user may also select a skill level threshold, which would exclude users who possess a skill level less than or greater than the skill level selected. In a further embodiment a user need not select a skill level, can search for any skill level, or select for a skill levels greater than or equal to the skill level selected, or the like. The user can then submit the selected search criteria, and the results can be displayed in the time and date matrix 650.

For example, if a user desires to participate in a tennis match and desires to play with someone who lives within twenty miles of the user's home and who is an expert in tennis, the user can select the area code where the user's house is located in the location box 610, select twenty miles in the radius box 620, select “tennis” in the activity box 630 and select “expert” in the skill level box 640. The user can then submit the selected information, and the search component can search the database for one or more entry or posting that match the given criteria. The result or results of the search are displayed in the time and date matrix 650, which depicts the one or more entry or posting, if any, found for users that fit the selected criteria.

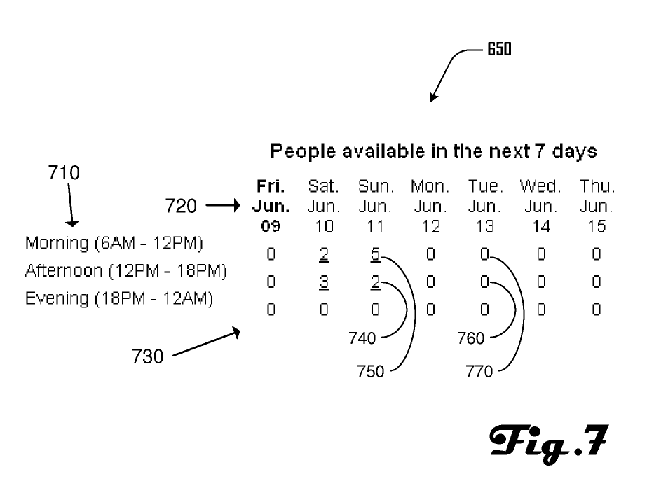

FIG. 7 is a screen shot of a time and date matrix 650 of the searching component, in accordance with one embodiment, which comprises a time of day column 710, a day row 720, and number matrix 730. The numerals of the time and date matrix 650 displays the results of a search for users who wish to participate in one or more activity and the rows of numbers correspond to a time of day and a day. Each row of the number matrix 730 corresponds to a row in the time of day column 710 and each column in the number matrix 730 represents a specific date, which corresponds to a column in the day row 720. For example, the numeral five 750 corresponds to the date Sunday, June 11th in the Morning between 6:00 AM and 12:00 PM, the marked numeral two 740 corresponds to Sunday, June 11th in the Afternoon between 12:00 PM and 18:00 PM, the first marked numeral zero 760 represents Sunday, June 13th in the Morning between 6:00 AM and 12:00 PM, and the second marked numeral zero 770 represents Sunday, June 13th in the Afternoon between 12:00 PM and 18:00 PM. In one embodiment, the axis of the time and date matrix can be switched, and the time of day column 710 can be a time of day row where the day row 720 depicted, and the day row 720 can be a day column where the time of day column 710 is depicted. In a further embodiment, there can be an hour, time period, week, month, year column or row on either axis of the time and date matrix 650. In a further embodiment, the time and date matrix 650 is configurable to display any time, time period, date, or group of dates, week, month or year.

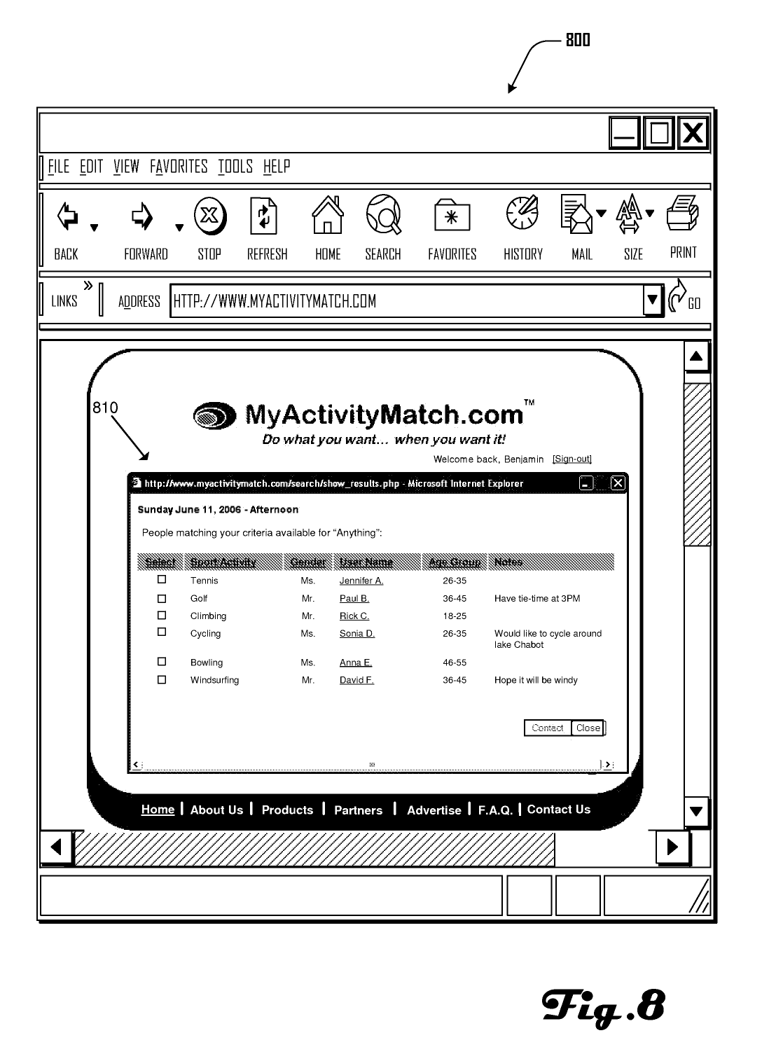

The numerals in the number matrix 730 further represent the number of users, user entries, or user postings that were found in a search performed by a user. For example, in a search corresponding to the date and time matrix 650, five users, user entries, or user postings correspond to the search for Sunday, June 11th in the Morning between 6:00 AM and 12:00 PM, two users, user entries, or user postings correspond to the search for Sunday, June 11th in the Afternoon between 12:00 PM and 18:00 PM and no users, user entries, or user postings correspond to the search for Sunday, June 13th in the Morning between 6:00 AM and 12:00 PM or Sunday, June 13th in the Afternoon between 12:00 PM and 18:00 PM. Additionally, the number matrix 730 is configurable to display the users, user entries, or user postings that correspond to a given date and time. A user can click, select, or engage a given numeral to display the users, user entries, or user postings corresponding to the given date and time, an example of which is depicted in FIG. 8.

In one embodiment, the time of day column 710 can comprise any periods of a day, divided into one or more segments of a day or other time period and the day row 720 can comprise any number of days or can be divided into weeks months or years. In a further embodiment, the number matrix can comprise any shape, box, symbol, numeral, or letter. In yet another embodiment, the time and date matrix 650 can be configured to display or present additional dates and times that are not presently displayed. For example, the time and date matrix can display a first week and can be configured to display a previous or subsequent week.

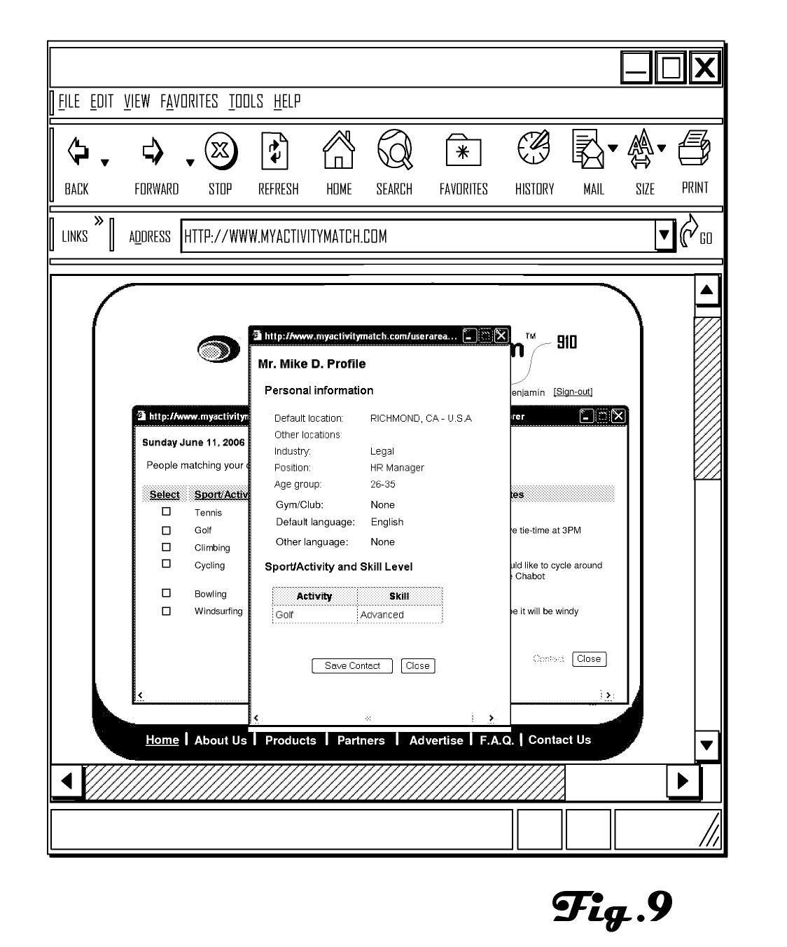

FIG. 8 is a screen shot of a still further module of a searching component 800, in accordance with one embodiment, which comprises a results window 810. FIG. 8 depicts the results for a specific date and time or time frame of a search for users or user posts corresponding to that day. The results window comprises the results of the search for the given date and time period, which comprises one or more piece of information regarding the one or more matching user or user post. In one embodiment the results window, is configurable to allow a user to contact one or more of the users displayed or to view the one or more information about the one or more user displayed. For example, FIG. 9 is a screen shot of an even further module of the searching component 900, in accordance with one embodiment, which comprises a pop-up window that presents information about a user.

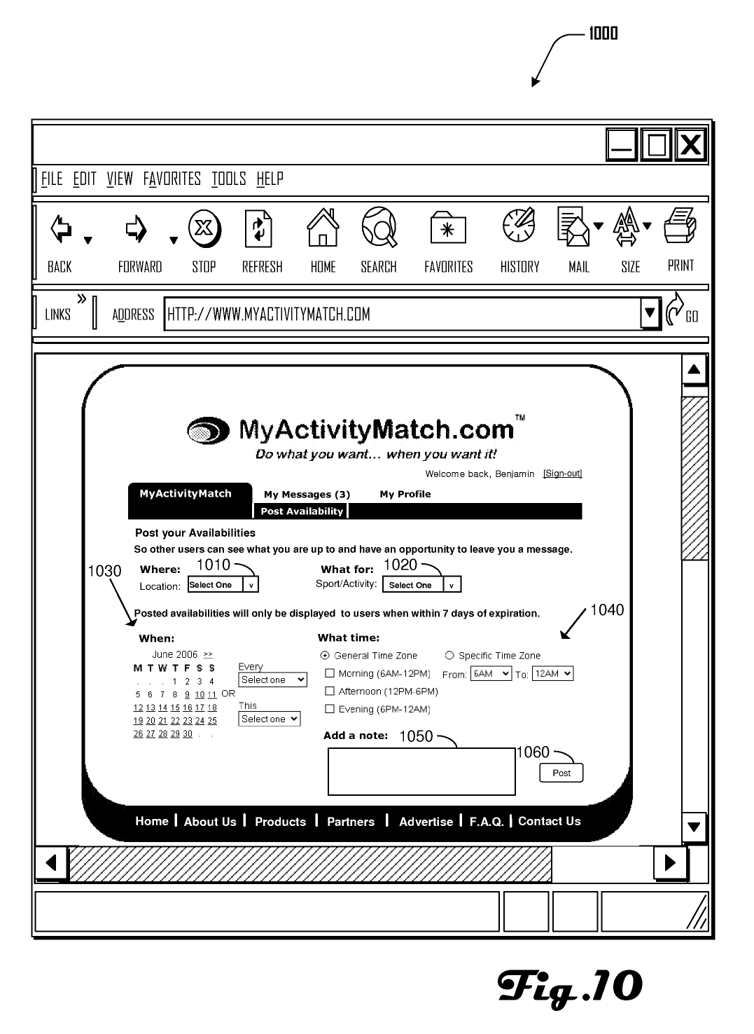

FIG. 10 is a screen shot of a module of a scheduling component 1000, in accordance with one embodiment, which comprises a location box 1010, an activity box 1020, a date selection field 1030, a time selection field 1040 a note field 1050, and a post button 1060. The module of a schedule component as depicted in FIG. 10 allows a user to post one or more date and time, date and time period, or recurring time or time period that the used desires to participate in one or more sport or activity. The user can configure the location box 1010 to select a location that the user desires to participate in an activity, which in one embodiment is associated with a zip code. In further embodiments, the location can be associated with latitude and longitude or other geographic location system. The user can further use the activity box 1020 to select one or more sport or activity that the user desires to participate in. The user can configure the date selection field 1030 to select one or more date that the user desires to participate in one or more activity or sport. The user can select a single date, or select a recurring time of the week, month, or day that the user desires to participate in one or more sport or activity. The user can select a time or time period on one or more date that the user desires to participate in one or more activity by configuring the time selection field 1040. Additionally, the user can configure the note field 1050 to create a note that will be associated with the posing of one or more date that the user desires to participate in one or more sport or activity.

Once a user has selected a location, sport or activity, one or more date and time, the user can post the user's availability by engaging, clicking or pushing the post button 1060. Posting the one or more date and time uploads, inputs, or saves the one or more posting in the database, where the one or more posting the joins a set of posting that can be searched by other users. In one embodiment, information can be automatically taken from the posting user's profile and added to the one or more posting created by the user. For example, skill level in one or more sport or activity, primary language, secondary language, age group, first name, last name, industry, position, or gym affiliation.

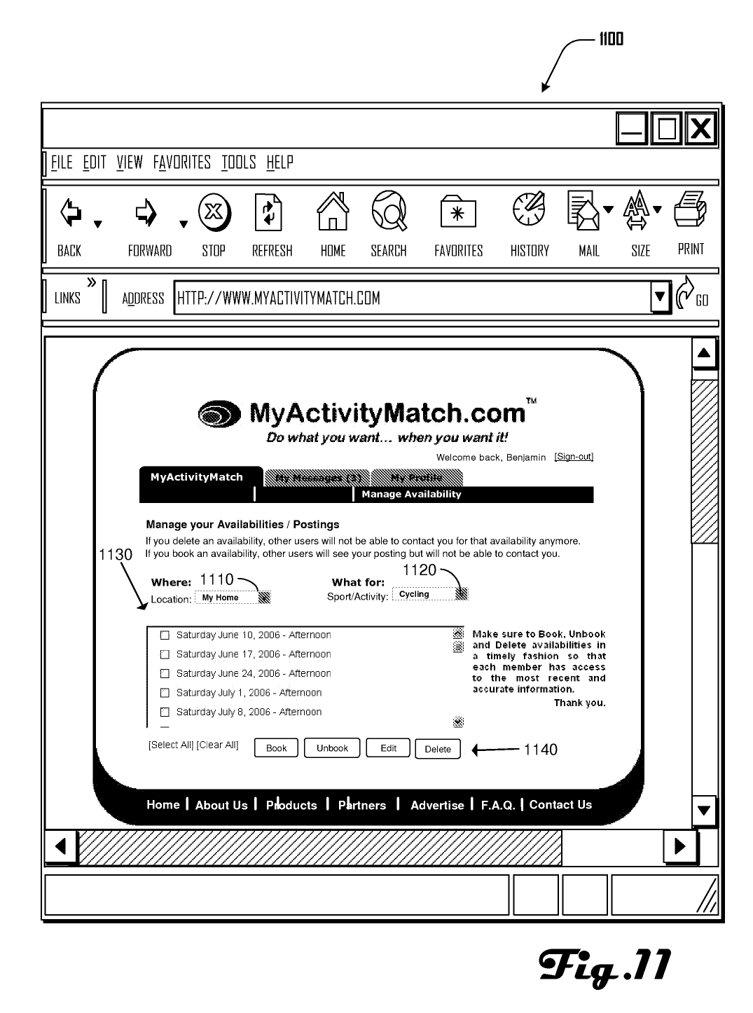

FIG. 11 is a screen shot of another module of the scheduling component 1100, in accordance with one embodiment, which comprises a location box 1110, an activity box 1120, a posting selection field 1200 and a posting configuration panel 1140. A user can configure this module of the scheduling component 1100 to book, un-book, edit, and delete one or more posting made by the user regarding the user's desire to participate in one or more sport or activity. The user can configure the location box 1110 to view only postings made for one or more location or can view any posting made by the user. Additionally, the user can configure the activity box 1120 to view only postings made for one or more sport or activity or can view any posting made by the user for any sport or activity. The posting selection field 1200 allows displays or presents one or more posting make by the user and the user can use the posting and selection field 1200 and the posting configuration panel 1140 to book, un-book, edit or delete one or more posting displayed in the posting selection field 1200.

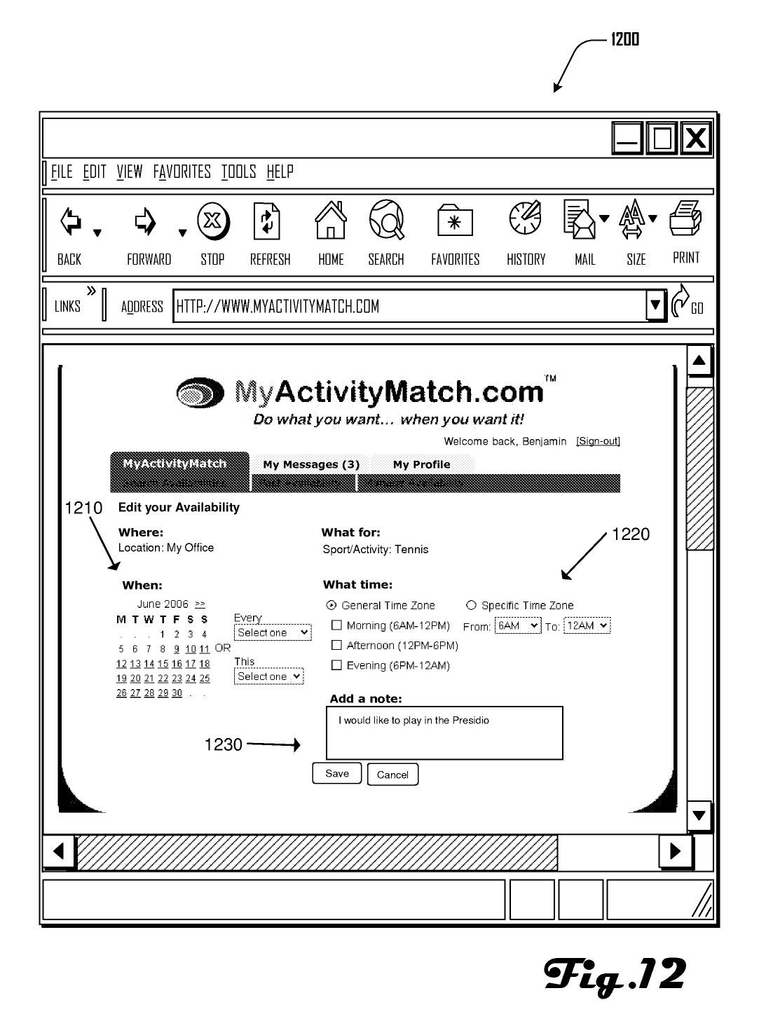

For example, if a user clicks, engages, or presses the edit button within the posting configuration panel 1140, the user can view, edit, change or delete a selected posting as depicted in FIG. 12, which is a screen shot of a still further module of the scheduling component 1200, in accordance with one embodiment. This module of the scheduling component 1200 comprises a date selection field 1210 a time selection field 1220 and a note field 1230. In one embodiment, old postings can be automatically removed or deleted from the database and therefore removed from a set of postings that can be searched by a user. For example, if a posting refers to a date that is past the present date, the posting will automatically be removed from the set of postings that can be searched by a user, deleted, or removed from the database.

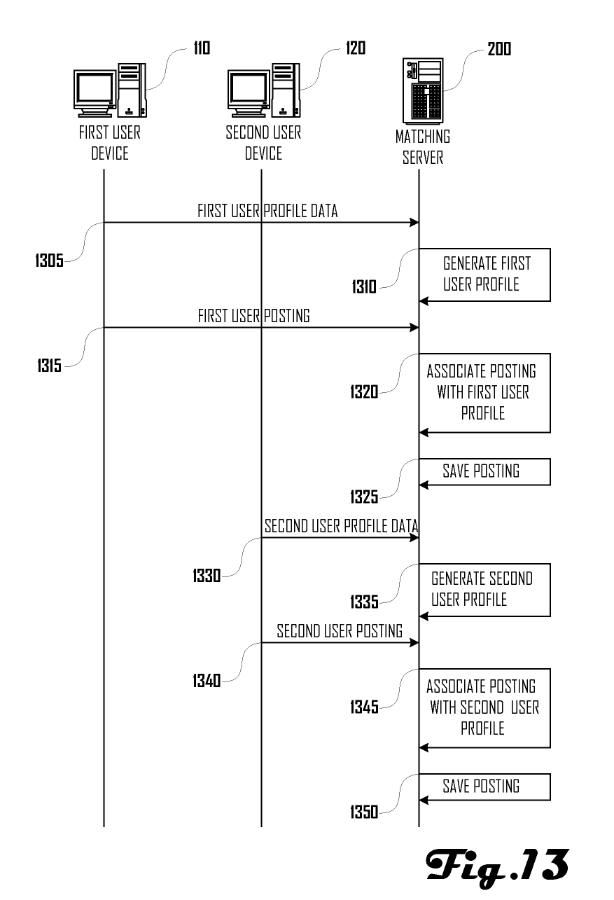

FIG. 13 is a diagram illustrating the actions taken by a first and second user device 110, 120, and a matching server 200 in accordance with various embodiments. Initially, first user profile data is sent 1305 to the matching server 200, which can include any information or configurations as described herein, and a first user profile is generated 1310. A posting can then be generated by the first user device 110 and sent 1315 to the matching server 200. The posting can be a posting regarding at least one activity that a user desires to participate in as described herein. The first user posting is associated 1320 with the first user profile and the posting is saved 1325.

Similarly, the second user device 120 can send 1330 second user profile data to the matching server 200, and the matching server 200 can generate 1335 a second user profile, which can be associated with a second user. The first user device can send 1340 a posting regarding an activity that the second user desires to participate in to the matching server 200, and the posting can be associated 1345 with the second user profile and saved 1350. In one embodiment, there can be a plurality of user devices that can each create a user profile and each send a plurality of postings to the matching server 200.

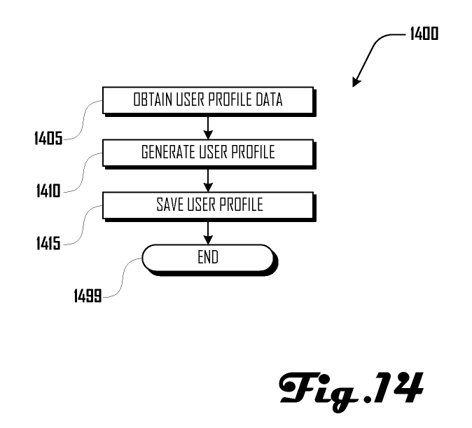

FIG. 14 is a flow diagram illustrating a user profile routine 1400 in accordance with various embodiments. The routine begins in block 1405 where user profile data is obtained 1405; then proceeds to block 1410, where a user profile is generated; and then proceeds to block 1415 where the user profile is saved. The routine is then done 1499.

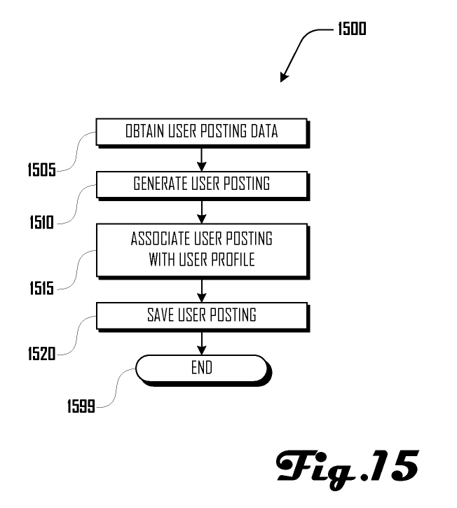

FIG. 15 is a flow diagram illustrating a user posting routine 1500 in accordance with various embodiments. In block 1505 user posting data is obtained and a user posting is generated in block 1510. The user posting is associated with the user's profile in block 1515 and in block 1520 the user posting is saved. The routine is then done 1599.

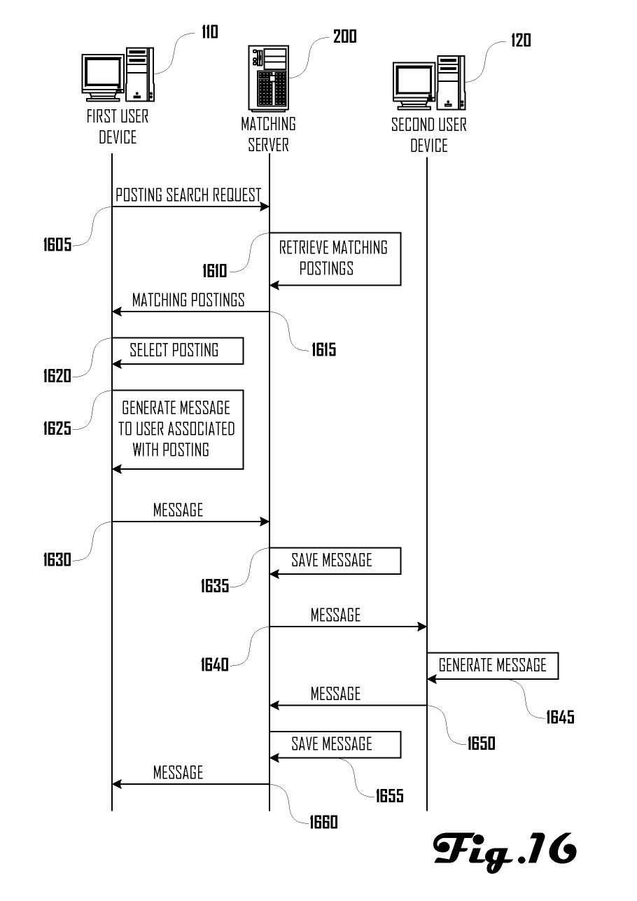

FIG. 16 is a diagram illustrating the actions taken by a first and second user device 110, 120 and a matching server 200 in accordance with various embodiments. The exemplary actions begin where the first user device 110 sends 1605 a posting search request to the matching server 200 and the matching server 200 retrieves 1610 postings matching the criteria defined in the posting search request and sends 1615 the matching postings to the first user device 110 where the postings are displayed. A user can select 1620 a posting and generate 1625 a message to a second user that is associated with the posting that was selected 1620. For example, a user can select 1620 a posting that defines a general time and location to participate in an activity, which can be a time and location that the first user desires to participate in said activity.

The first user device 110 sends 1630 the message to the matching server 200, which saves 1635 the message and sends 1640 the message to the second user device 120. In one embodiment, the message can be automatically sent 1640 to the second user device 120, or the second user device 120 can request a message from the matching server 200.

The second user device can generate 1645 a message and the message can be sent 1650 to the matching server 200, where the message is saved 1655 by the matching server 200, and sent 1660 to the first user device 110. For example, a second user associated with the second user device 120 can reply to the message received from a first user associated with the first user device 110.

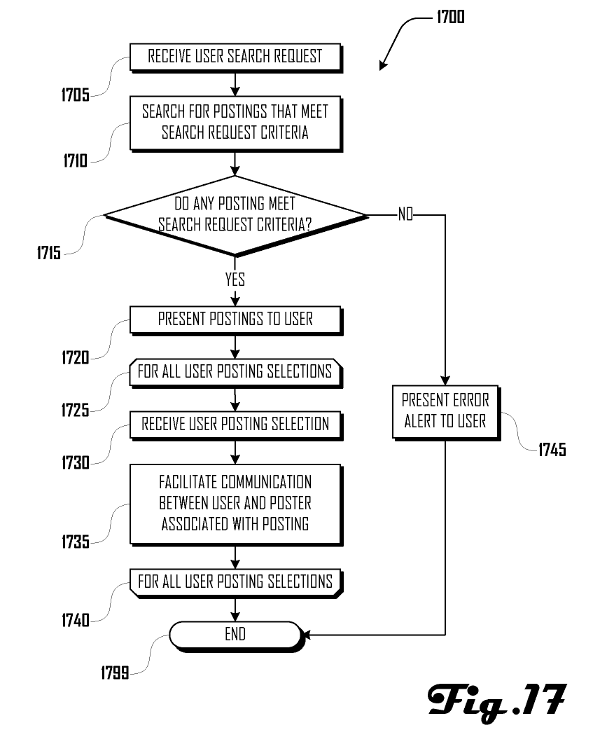

FIG. 17 is a flow diagram illustrating an activity partner matching routine 1700 in accordance with various embodiments. The activity partner matching routine 1700 begins in block 1705 where a user search request is received and continues to block 1710, where a search is made for postings that meet search criteria as defined in the user search request. In decision block 1715 a decision is made whether any postings meet the search criteria as defined in the user search request. If no postings meet the criteria, the activity partner matching routine 1700 continues to block 1745, where an error alert is presented to the user device that made the user search request, and the activity partner matching routine 1700 is done 1799. In one embodiment, a user device does not receive an error alert, but is instead presented with no matching postings.

However, if at least one posting does meet the search criteria as defined by the user search request, the activity partner matching routine 1700 continues to block 1720, where matching postings are presented to the user. Looping block 1725 begins a loop and the following actions are taken for all user posting selections. In block 1730, a user posting selection is received and in block 1735 communication between a posting activity partner associated with the posting and the user is facilitated. Looping block 1740 ends the loop for all user posting selections and the routine is done 1799.

In one embodiment, the plurality of posting activity partners are in communication with a website that is configurable to allow them to each create a profile and make postings, which can be stored in a database and accessed or searched by a first user or one or more of the plurality of posting activity partners. The profile or posting of a user or a posting activity partner can comprise any information including email address, password, first name, last name, middle name, user identification, age, age group, gender, country, zip code, industry that the one or more user works in, work position, primary language, secondary language, gym affiliation, one or more sport that the posting activity partner or user desires to participate in, one or more activity that the posting activity partner or user desires to participate in, the posting activity partner's or user's skill level in one or more sport or activity, one or more location that the posting activity partner or user desires to participate in an activity, birth date, consent to one or more contract or agreement, contact preferences, one or more location, a date and time that the posting activity partner or user desires to participate in one or more sport or activity, one or more recurring time of the week that the posting activity partner or user desires to participate in one or more sport or activity, notes associated with one or more date and time or recurring time of the week that the user desires to participate in one or activity, telephone number, fax number, IP address, Instant Messager® identification, Skype® number, information about one or more user of the matching server, credit card information, religion, and the like.

In another embodiment, when matching postings are presented grouped by date and time and the postings can be displayed in a time and date matrix, where the first axis is a time, time period, day, week or month and the second axis is a specific hour, time of day, day, week, month. The time and date matrix can further comprise a number matrix, wherein each number represents the number of postings that fit the criteria defined by the first user, and which correspond to the time, time period, day, week or month as designated by the time and date matrix (see, e.g. FIG. 7). In one embodiment, a user can click, push, or engage any numeral to view the posting that fit into the time period that the numeral represents. In one embodiment, there can be a plurality of posting activity partners and users. In a still further embodiment, an individual who is a posting activity partner can also be a user. In a still further embodiment, both posting activity partners and users can post a posting and search for postings that meet their criteria.

Additionally, although specific embodiments have been illustrated and described herein, it will be appreciated by those of ordinary skill in the art and others, that a wide variety of alternate and/or equivalent implementations may be substituted for the specific embodiment shown in the described without departing from the scope of the embodiments described herein. This application is intended to cover any adaptations or variations of the embodiment discussed herein. While various embodiments have been illustrated and described, as noted above, many changes can be made without departing from the spirit and scope of the invention. Accordingly, the scope of the invention is not limited by the disclosure of these embodiments.

1. A computer implemented method for matching activity partners, the method comprising the steps:
obtaining a posting from a posting activity partner, where each posting comprises:
an activity that said posting activity partner desires to participate in;
a date that said posting activity partner desires to participate in said activity;
a time that said posting activity partner desires to participate in the activity on said date; and
a location that said posting activity partner desires to participate in the activity;
obtaining a posting search request from a requesting activity partner comprising search criteria of at least a location and an activity;
determining whether said posting matches the search criteria of the posting search request;
if said posting matches the search criteria of the posting search request, presenting at least said posting in a matrix that comprises, a day row and a number matrix; and
providing a communication link between the requesting activity partner and said posting activity partner.

2. The method of claim 1, wherein each posting further defines a skill level of the associated posting activity partner in the activity that the posting activity partner desires to participate, and wherein the set of criteria defined by the requesting activity partner further comprises skill level of a desired activity partner.

3. The method of claim 2, wherein each posting further defines a gym affiliation of the associated posting activity partner in the activity that the posting activity partner desires to participate, and wherein the set of criteria defined by the requesting activity partner further comprises gym affiliation of a desired activity partner.

4. The method of claim 3, wherein each posting further defines a primary and secondary language of the associated posting activity partner in the activity that the posting activity partner desires to participate, and wherein the set of criteria defined by the requesting activity partner further comprises primary and secondary language of a desired activity partner.

5. The method of claim 1, wherein the plurality of posting activity partners uses a website to create and post the plurality of postings, and wherein the requesting activity partner uses a website to search the plurality of postings.

6. The method of claim 1 wherein the time and date matrix further comprises a time of day column.

7. The method of claim 6, wherein the time of day column comprises three times of day.

8. The method of claim 7, wherein the day row comprises seven columns, wherein each column corresponds to seven consecutive days in a week,

9. A computing device having a processor and a memory with computer executable instructions which, when executed by said processor, perform the method of claim 1.

10. A computer readable medium having executable instructions, which when executed perform the method of claim 1.

11. A computing device, the device configured to match activity partners, the device comprising:
a profile means for obtaining a plurality of postings from a plurality of posting activity partners, where each posting is associated with a posting activity partner and comprises:
an activity that the posting activity partner desires to participate in;
a date that the posting activity partner desires to participate in said activity;
a time that the posting activity partner desires to participate in the activity on said date; and
a location that the posting activity partner desires to participate in the activity,
a searching means for receiving a posting search request from a first user device comprising the criteria of location and activity, determining whether one or more of the plurality of postings matches the search criteria of the posting search request, and presenting a plurality of postings matching the criteria of the posting search request that are presented in a matrix that comprises a day row, and a number matrix; and
a communication means for providing a communication link between the requesting activity partner and at least one posting activity partner associated with at least one of the matching plurality of postings.

12. The computing device of claim 11 further comprising an alert means for presenting an alert to the requesting activity partner.

13. The computing device of claim 11, wherein the one or more posting further comprises a range of time on the date the posting activity partner desires to participate in the activity that the posting activity partner desires to participate in the activity.

14. The computing device of claim 13 wherein the choices for the range of time on the date the posting activity partner desires to participate in the activity that the posting activity partner desires to participate in the activity consist of morning, afternoon, and afternoon

15. The computing device of claim 11, wherein the one or more posting further comprises a time on the date the posting activity partner desires to participate in the activity that the posting activity partner desires to participate in the activity.

16. The computing device of claim 13, wherein the one or more posting further comprises a skill-level of the posting activity partner for the activity that the posting activity partner desires to participate in and wherein the set of criteria further comprises a desired skill level for an activity partner.

17. The computing device of claim 16, wherein the one or more posting further comprises a gym affiliation of the posting activity partner and wherein the set of criteria further comprises a desired gym affiliation for an activity partner.

18. The computing device of claim 11, wherein the searching component is further configurable to group and present, in a time and date matrix, the set of one or more posting that matches the set of criteria defined by the user.

19. The computing device of claim 18, wherein the time and date matrix further comprises a time of day column.

20. The computing device of claim 19, wherein the day row comprises seven columns, wherein each column corresponds to seven consecutive days in a week
